(19) United States
(12) Patent Application Publication
(10) Pub. No.: US 2024/0393671 A1
(43) Pub. Date: Nov. 28, 2024

(54) INFORMATION PROCESSING SYSTEM AND METHOD AND NON-TRANSITORY COMPUTER READABLE MEDIUM

(71) Applicant: FUJIFILM Business Innovation Corp., Tokyo (JP)

(72) Inventors: Tsutomu SHIIHARA, Kanagawa (JP); Masatoshi DEGUCHI, Kanagawa (JP); Hideaki SUGIMOTO, Kanagawa (JP); Shoko MATSUNAGA, Kanagawa (JP)

(73) Assignee: FUJIFILM Business Innovation Corp., Tokyo (JP)

(21) Appl. No.: 18/502,143

(22) Filed: Nov. 6, 2023

(30) Foreign Application Priority Data
May 26, 2023 (JP) 2023-086948

(51) Int. Cl. G03B 35/20; G06F 16/16

(52) U.S. Cl. CPC G03B 35/20; G06F 16/16

(57) ABSTRACT

An information processing system includes a processor configured to: link a first file image with a first user image and display the first file image and the first user image, the first file image representing a file linked with an account of a first user, the first user image representing the first user; and link a second file image with a second user image and display the second file image and the second user image together with the first file image and the first user image, the second file image representing a file linked with an account of a second user, the second user image representing the second user, the second user being different from the first user.

### CROSS-REFERENCE TO RELATED APPLICATIONS

This application is based on and claims priority under 35 USC 119 from Japanese Patent Application No. 2023-086948 filed May 26, 2023.

### BACKGROUND

### (i) Technical Field

The present disclosure relates to an information processing system and method and a non-transitory computer readable medium.

### (ii) Related Art

A private work space where a desk and a display are installed is known.

Japanese Unexamined Patent Application Publication No. 2020-167614 discloses the following remote communication device. A remote communication device located at a first site obtains a spatial image of another remote communication device located at a second site and displays this spatial image at the first site. The other remote communication device located at the second site also obtains a spatial image of the remote communication device located at the first site and displays this spatial image at the second site.

<URL: https://www.prism.ricoh/shiro/>describes that an image stored in a personal computer or a smartphone is displayed on a wall surface.

### SUMMARY

A known private work space is a space including only a desk and a display. This may not be sufficient for a user to do some work in collaboration with another user.

Aspects of non-limiting embodiments of the present disclosure relate to providing of an environment where a user can more easily do some work in collaboration with another user than in a work space including only a desk and a display.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including a processor configured to: link a first file image with a first user image and display the first file image and the first user image, the first file image representing a file linked with an account of a first user, the first user image representing the first user; and link a second file image with a second user image and display the second file image and the second user image together with the first file image and the first user image, the second file image representing a file linked with an account of a second user, the second user image representing the second user, the second user being different from the first user.

### BRIEF DESCRIPTION OF THE DRAWINGS

Exemplary embodiments of the present disclosure will be described in detail based on the following figures, wherein:

FIG. 1 is a perspective view of a booth unit;

FIG. 2 is a front view of the booth unit;

FIG. 3 is a top view of the booth unit;

FIG. 4 illustrates an example of a projection device;

FIG. 5 illustrates another example of the projection device;

FIG. 6 is a top view of an example of a space forming member different from that shown in FIGS. 1 through 3;

FIG. 7 is a perspective view of a booth unit according to a modified example;

FIG. 8 is a block diagram of a system including a control device;

FIG. 9 illustrates a third surface;

FIG. 10 illustrates the third surface;

FIG. 11 illustrates a first surface;

FIG. 12 illustrates the third surface;

FIG. 13 is a perspective view of two booth units;

FIG. 14 illustrates the third surface;

FIG. 15 illustrates the third surface;

FIG. 16 illustrates the third surface;

FIG. 17 illustrates the third surface;

FIG. 18 illustrates the third surface;

FIG. 19 illustrates the third surface;

FIG. 20 is a block diagram illustrating an example of the configuration of an overall system of a second exemplary embodiment;

FIG. 21 illustrates an example of a management table for managing accounts;

FIG. 22 is a flowchart illustrating a processing procedure of the second exemplary embodiment;

FIG. 23 illustrates a third surface; and

FIG. 24 illustrates the third surface.

### DETAILED DESCRIPTION

### First Exemplary Embodiment

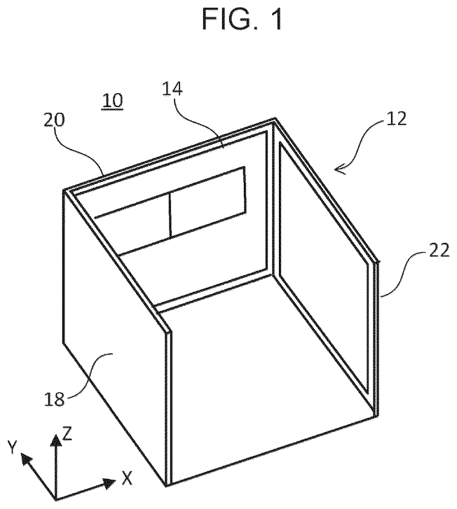

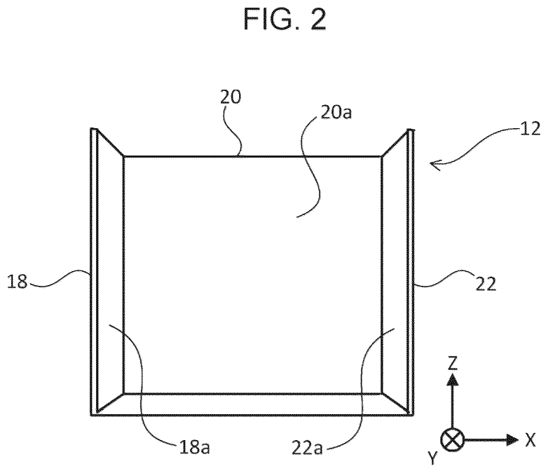

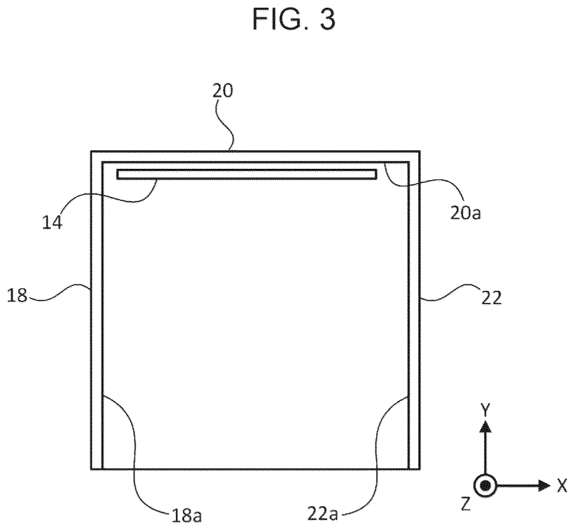

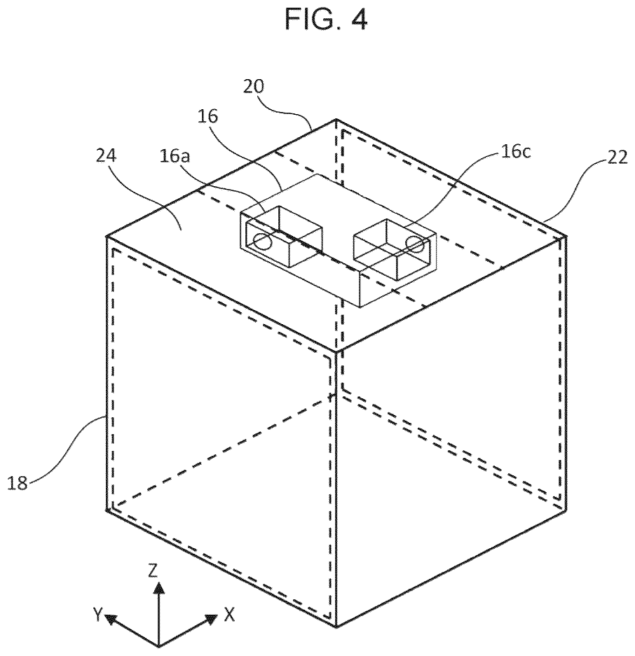

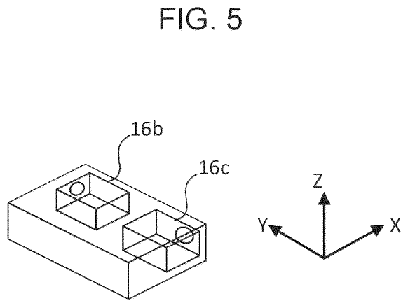

A booth unit according to a first exemplary embodiment will be described below with reference to FIGS. 1 through 5. FIG. 1 is a perspective view of a booth unit 10 according to the first exemplary embodiment. FIG. 2 is a front view of the booth unit 10. FIG. 3 is a top view of the booth unit 10. FIGS. 4 and 5 illustrate examples of a projection device. In FIGS. 1 through 5, a three-dimensional Cartesian coordinate system consisting of the x axis, y axis, and z axis perpendicular to each other is defined.

The booth unit 10 includes a space forming member 12, a digital whiteboard 14, and a projection device 16. The booth unit 10 may be installed indoors or outdoors.

The space forming member 12 forms a space surrounded by at least three surfaces. For example, as illustrated in FIGS. 1 through 3, the space forming member 12 includes a first side wall 18, a second side wall 20, and a third side wall 22. The first side wall 18 forms a first surface 18a inside the booth unit 10. The second side wall 20 forms a second surface 20a inside the booth unit 10. The third side wall 22 forms a third surface 22a inside the booth unit 10. The space partially surrounded by the first side wall 18, second side wall 20, and third side wall 22 is formed inside the space forming member 12. The first surface 18a, second surface 20a, and third surface 22a are surfaces (inner surfaces) formed inside this space.

As illustrated in FIG. 4, the space forming member 12 includes a ceiling 24. For the sake of representation, the ceiling 24 is not shown in FIGS. 1 through 3. The space forming member 12 may include a floor or may not necessarily include it.

For example, the first surface 18a, second surface 20a, third surface 22a, and ceiling 24 are interconnected to each other with interconnecting members, such as bolts and nuts or hinges. All or some of the first surface 18a, second surface 20a, third surface 22a, and ceiling 24 may be integrated with each other. Alternatively, all or some of the first surface 18a, second surface 20a, third surface 22a, and ceiling 24 are not interconnected nor integrated with each other and may instead be installed with a space therebetween and be supported by a support member, such as a stand.

As shown in FIG. 4, the projection device 16 may be installed on the ceiling 24. The ceiling 24 is not a required element for the space forming member 12. If the space forming member 12 does not include the ceiling 24, the projection device 16 may hang from a ceiling which does not form the booth unit 10 or be supported by a support member, such as a stand.

The second side wall 20 is disposed next to the first side wall 18 to intersect with the first side wall 18. With this arrangement, the second surface 20a is located next to the first surface 18a and intersects with the first surface 18a. The third side wall 22 is disposed next to the second side wall 20 to oppose the first side wall 18 and to intersect with the second side wall 20. With this arrangement, the third surface 22a is located next to the second surface 20a and opposes the first surface 18a and intersects with the second surface 20a.

The sizes (length and width, for example) and the shapes of the first surface 18a, second surface 20a, and third surface 22a may be the same or may be different from each other. The surfaces may have a rectangular shape or a curved shape.

The digital whiteboard 14 is a device that receives information, such as handwritten characters and figures, and displays an image. For example, the digital whiteboard 14, which includes a display, digitally converts information, such as characters and figures drawn with a finger or a stylus pen, and displays the converted information on the surface of the display. The digitally converted information may be stored in a memory included in the digital whiteboard 14 or in an external memory. The digitally converted information may be output to an external device, such as a terminal device, a server, or another device, or be printed with a printer. The digital whiteboard 14 may receive information, such as an image or a character string, from an external memory or an external device and display such information on the display. The digital whiteboard 14 may include one or plural displays. One display may be disposed on one surface of the booth unit 10 or plural displays may be disposed on one surface of the booth unit 10.

The digital whiteboard 14 is disposed on one of the first surface 18a, second surface 20a, and third surface 22a. The digital whiteboard 14 may be fixed to or lean against one of the first surface 18a, second surface 20a, and third surface 22a. The digital whiteboard 14 may be disposed in front of one of the first surface 18a, second surface 20a, and third surface 22a with a space therebetween.

The projection device 16 is a projector, for example, and projects an image on at least one of the first surface 18a, second surface 20a, and third surface 22a, which is not provided with the digital whiteboard 14. With this configuration, an image is displayed on at least one surface on which the digital whiteboard 14 is not provided. The image may be a still image or a video image. The data format of an image is not restricted to a particular format, and a document and text may also be displayed as an image. A speaker may be provided inside or outside the space forming member 12 and sound may be emitted from the speaker. For example, sound may be emitted from the speaker together with a displayed image.

In the example shown in FIGS. 1 through 3, the digital whiteboard 14 is disposed on the second surface 20a, and the projection device 16 projects an image on at least one of the first surface 18a and the third surface 22a.

As illustrated in FIG. 4, the projection device 16 includes projectors 16a and 16c. The projector lens provided in the projector 16a faces the first surface 18a and the projector 16a projects an image on the first surface 18a. The projector lens provided in the projector 16c faces the third surface 22a and the projector 16c projects an image on the third surface 22a. The projection device 16 may project an image on the first surface 18a by using the projector 16a and also project the image on the third surface 22a by using the projector 16c or project the image on one of the first surface 18a and the third surface 22a.

FIG. 5 illustrates another example of the projection device 16. The projection device 16 shown in FIG. 5 includes projectors 16b and 16c. The projector lens provided in the projector 16b faces the second surface 20a and the projector 16b projects an image on the second surface 20a. When projecting an image on the second surface 20a and the third surface 22a, for example, the projection device 16 shown in FIG. 5 is used.

The configurations of the projection devices 16 shown in FIGS. 4 and 5 are only examples. The projection device 16 may include at least one of the projectors 16a, 16b, and 16c and project an image on at least one of the first surface 18a, second surface 20a, and third surface 22a. A microphone and a speaker may be provided in or near the projection device 16.

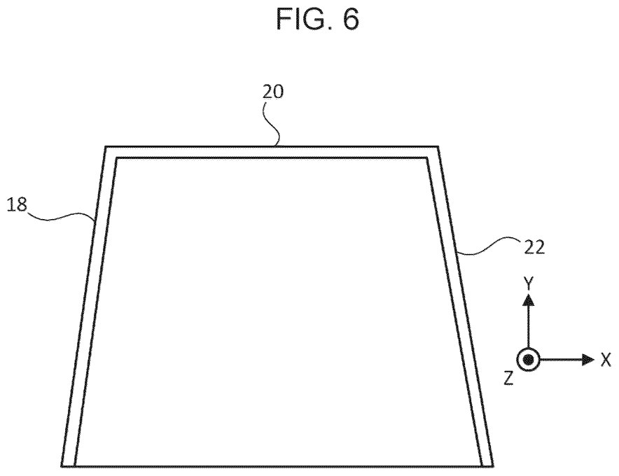

In the example shown in FIGS. 1 through 3, the angle formed between the first side wall 18 and the second wide wall 20 (hereinafter called the angle α for the sake of convenience) and the angle formed between the second side wall 20 and the third side wall 22 (hereinafter called the angle β for the sake of convenience) are 90° or substantially 90°. However, this is only an example, and the angles α and β may be angles other than 90°. FIG. 6 illustrates an example of such a case. FIG. 6 is a top view of another example of the space forming member 12. In the example in FIG. 6, the angles α and β are larger than 90°. Conversely, the angles α and β may be smaller than 90°. The angles α and β may be the same or may be different from each other. The first side wall 18, second side wall 20, and third side wall 22 may be connected to each other so as to be foldable, so that a user can change the angles α and β in accordance with the mode of use.

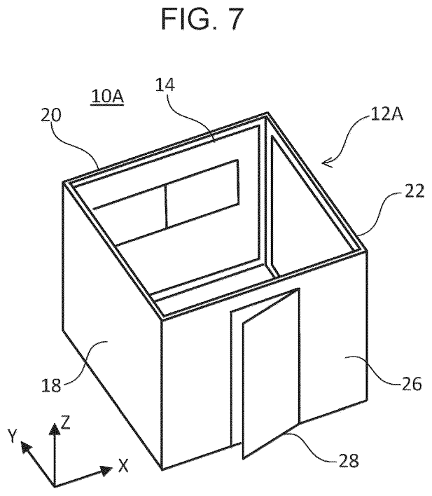

A booth unit 10A according to a modified example is shown in FIG. 7. FIG. 7 is a perspective view of the booth unit 10A. The booth unit 10A includes a space forming member 12A instead of the space forming member 12. The space forming member 12A includes a first side wall 18, a second side wall 20, and a third side wall 22 as in the space forming member 12, and also includes a fourth side wall 26. The fourth side wall 26 is disposed to oppose the second side wall 20. An enclosed space, for example, is formed by the first side wall 18, second side wall 20, third side wall 22, and fourth side wall 26. Although the ceiling 24 is not shown in FIG. 7, the space forming member 12A includes the ceiling 24, as in the space forming member 12 of the booth unit 10, and the projection device 16 is installed on the ceiling 24. The ceiling 24 is not a required element for the space forming member 12A. If the space forming member 12A does not include the ceiling 24, the projection device 16 may hang from a ceiling which does not form the booth unit 10A or be supported by a support member, such as a stand. The space forming member 12A may include a floor or may not necessarily include it.

A door 28 is provided on the fourth side wall 26. A user using the booth unit 10A can open the door 28 and enter the booth unit 10A (the space enclosed by the first side wall 18, second side wall 20, third side wall 22, and fourth side wall 26) from the outside of the booth unit 10A and can also go out of the booth unit 10A. An electronic lock may be provided on the door 28 and the door 28 may be locked by the electronic lock. When user authentication for a user succeeds, for example, the electronic lock is unlocked and the user is allowed to enter the booth unit 10A.

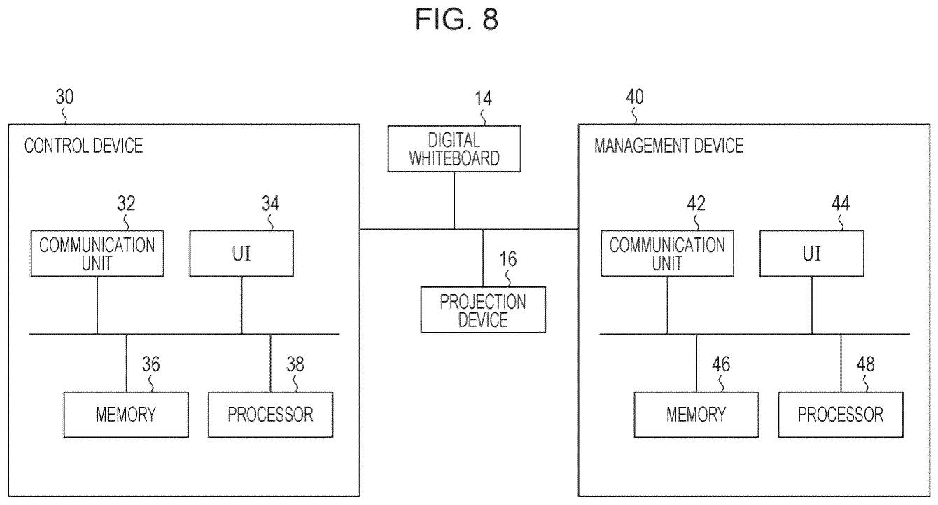

A control device 30 will be explained below with reference to FIG. 8. FIG. 8 is a block diagram of a system including the control device 30. The control device 30 controls the booth units 10 and 10A. The control device 30 may be disposed inside a space at least partially surrounded by the space forming member 12 or outside the space. Likewise, the control device 30 may be disposed inside a space surrounded by the space forming member 12A of the booth unit 10A or outside the space.

The control device 30 includes a communication unit 32, a user interface (UI) 34, a memory 36, and a processor 38.

The communication unit 32 includes one or plural communication interfaces each having a communication chip and a communication circuit, for example, and has a function of sending data to another device and a function of receiving data from another device. The communication unit 32 may include a wireless communication function, such as Wi-Fi (registered trademark) and/or a wired communication function. The communication unit 32 may include a short-distance wireless communication function, such as Bluetooth (registered trademark) and a radio frequency identifier (RFID).

The UI 34 includes a display and an operation unit. The display is a liquid crystal display or an electroluminescence (EL) display, for example. The operation unit is a keyboard, a mouse, and input keys, or an operation panel, for example. The UI 34 may be a touchscreen having both functions as a display and an operation unit. The UI 34 may include a microphone and a speaker. For example, the UI 34 may be disposed inside a space at least partially surrounded by the space forming member 12 or outside the space. If the booth unit 10A is used, the control device 30 is disposed inside a space surrounded by the space forming member 12A or outside the space.

The memory 36 is a device having one or multiple storage regions for storing data. The memory 36 is a hard disk drive (HDD), a solid state drive (SSD), various memory units (such as a random access memory (RAM), a dynamic random access memory (DRAM), a non-volatile random access memory (NVRAM), and a read only memory (ROM)), another type of storage device (such as an optical disc), or a combination thereof.

The processor 38 controls operations of the individual elements of the booth units 10 and 10A. For example, the processor 38 performs control to cause the projection device 16 to project an image. The processor 38 may control the digital whiteboard 14. Alternatively, the digital whiteboard 14 may include a processor and be controlled by this processor.

For example, the processor 38 may receive an image from an external device via a communication channel, such as the internet or a local area network (LAN), and cause the projection device 16 to project the image. Examples of the external device are a terminal device, an image server, a document management system, a cloud server, and another booth unit 10. The processor 38 may cause the projection device 16 to project an image stored in the memory 36. A terminal device of a user, such as a smartphone, a personal computer (PC), or a tablet PC, may be connected to the control device 30, and the processor 38 may obtain from the terminal device an image stored in the terminal device. For example, when the user operates the UI 34 or the UI of the terminal device and selects an image to be projected, the processor 38 causes the projection device 16 to project the selected image.

When the user operates the UI 34 or the UI of the terminal device and specifies a surface on which an image is to be projected, the processor 38 performs control to cause the projection device 16 to project an image on the surface specified by the user. The surface on which an image is to be projected may be preset.

The processor 38 may cause the projection device 16 to project information input into the digital whiteboard 14 or an image displayed on the digital whiteboard 14. This can project and display information input into the digital whiteboard 14 or an image displayed on the digital whiteboard 14 on at least one of the first surface 18a, second surface 20a, and third surface 22a.

The processor 38 may send information input into the digital whiteboard 14 or an image displayed on the digital whiteboard 14 to a device other than the booth unit 10 via a communication channel, such as the internet or a LAN, or store such information or such an image in the memory 36. The processor 38 may receive information to be displayed on the digital whiteboard 14 and display it on the digital whiteboard 14.

If the booth unit 10A is used, the processor 38 may control the electronic lock provided on the door 28 of the booth unit 10A. For example, the processor 38 locks the electronic lock in response to receiving of an instruction to lock the door 28 and unlocks the electronic lock in response to receiving of an instruction to unlock the door 28. An instruction to lock or unlock the door 28 may be sent to the processor 38 via a communication channel or may be received by a receiver provided on or near the door 28 and be output to the processor 38.

The control device 30 may control plural booth units 10 and/or plural booth units 10A. The control device 30 may be provided for each of the booth units 10 and for each of the booth units 10A.

For example, the processor 38 of the control device 30 detects the surface on which the digital whiteboard 14 is provided and performs control to cause the projection device 16 to project an image on at least one of the surfaces which are not provided with the digital whiteboard 14. In one example, a camera that images the inside of the booth unit 10 is installed, and the processor 38 analyzes an image captured by the camera and detects the surface provided with the digital whiteboard 14. In another example, a user may operate the UI 34 and specifies the surface provided with the digital whiteboard 14. The user may specify the surface on which an image is to be projected and the processor 38 may perform control to cause the projection device 16 to project the image on the surface specified by the user. In another example, if the orientation of the projection device 16 is predetermined, the digital whiteboard 14 may be provided on the surface on which an image is not to be projected. For instance, if the projectors 16a and 16c are used, the digital whiteboard 14 is provided on the second surface 20a. If the projectors 16b and 16c are used, the digital whiteboard 14 is provided on the first surface 18a.

The overall system may be constituted by the control device 30 and a management device 40. The overall system may include at least one of the digital whiteboard 14 and the projection device 16. The overall system may include another device.

The control device 30 and the management device 40 communicate with each other via a communication channel, such as the internet or a LAN.

The management device 40 controls a reservation for the use of the booth unit 10 or 10A. The management device 40 will be described below in detail. Hereinafter, processing to be executed when the booth unit 10 is used will be explained. When the booth unit 10A is used, processing is executed in a similar manner to when the booth unit 10 is used.

The management device 40 includes a communication unit 42, a UI 44, a memory 46, and a processor 48.

The communication unit 42 includes one or plural communication interfaces each having a communication chip and a communication circuit, for example, and has a function of sending data to another device and a function of receiving data from another device. The communication unit 42 may include a wireless communication function and/or a wired communication function.

The UI 44 includes a display and an operation unit. The display is a liquid crystal display or an EL display, for example. The operation unit is a keyboard, a mouse, and input keys, or an operation panel, for example. The UI 44 may be a touchscreen having both functions as a display and an operation unit.

The memory 46 is a device having one or multiple storage regions for storing data. The memory 46 is a HDD, a SSD, various memory units (such as a RAM, a DRAM, a NVRAM, and a ROM), another type of storage device (such as an optical disc), or a combination thereof.

The processor 48 controls operations of the individual elements of the management device 40.

For example, the management device 40 links information indicating the time at which the booth unit 10 is to be used (that is, the time at which a user is allowed to use the booth unit 10, which may hereinafter simply be called the usage time) with user identification information for identifying a user having reserved the booth unit 10 for this usage time. The management device 40 then manages reservation information including the above-described linked items of information. The usage time is indicated by a date and a time period for which the booth unit 10 is used, for example. If multiple booth units 10 are included in the overall system, the management device 40 links, for each booth unit 10, information indicating the usage time with user identification information and manages a reservation for each booth unit 10. When a user has reserved a booth unit 10 for a certain usage time, this user is allowed to use the booth unit 10 during this usage time. User identification information for identifying a user to enter the booth unit 10 may be included in reservation information. In this case, user identification information for identifying a user having reserved the booth unit 10 may be included in the reservation information or may not be included therein. If user authentication is performed at the booth unit 10, user identification information for identifying a user to enter the booth unit 10 is used. For example, there may be a case in which a reservation is made by a user other than a user actually using the booth unit 10 or a case in which a user has made a reservation but is unable to use the booth unit 10 for some reason. In such cases, if user identification information for identifying a user to enter the booth unit 10 is included in reservation information, this information can be used to perform user authentication.

Reservation management information is stored in the memory 46. The reservation management information is information for managing a reservation for using a booth unit 10. For example, the reservation management information includes booth identification information for identifying a booth unit 10, usage time information indicating the usage time for this booth unit 10, and user identification information for identifying a user having reserved the booth unit 10. For each booth unit 10, booth identification information, usage time information, and user identification information are linked with each other and are included in reservation management information.

The booth identification information includes, for example, information indicating the name of a booth unit 10, the ID of the booth unit 10, and information indicating a location where the booth unit 10 is installed (position information, for example).

The user identification information includes, for example, information indicating the name of a user and the account of the user (user ID or an email address, for example). The user identification information may include information for identifying a terminal device used by the user, such as a media access control (MAC) address, an internet protocol (IP) address, and a serial number. The user identification information may be biological information of the user.

In response to receiving of a request to make a reservation for a booth unit 10 from a terminal device, the processor 48 registers this reservation request in reservation management information. For example, when a user operates a terminal device and makes a reservation request for a booth unit 10 by specifying this booth unit 10 and a usage time, the processor 48 links booth identification information indicating the booth unit 10, usage time information indicating the usage time, and user identification information indicating the user having reserved the booth unit 10 with each other and registers them in reservation management information. A booth unit 10 may be reserved using a unit time for a reservation, for example.

The management device 40 may be provided in a booth unit 10. That is, a reservation for a booth unit 10 may be managed by this booth unit 10. The management device 40 may be included in the control device 30.

Examples will be described below.

### First Example

In a first example, the digital whiteboard 14 is provided on the second surface 20a, and, under the control of the control device 30, the projection device 16 projects an image on the first surface 18a or the third surface 22a in accordance with the attribute of an authenticated user. For example, user authentication may be performed when a user enters a booth unit 10 or after the user has entered the booth unit 10. For example, user identification information is used to perform user authentication.

In one example, a receiver is installed in the booth unit 10, and attribute information indicating the attribute of a user is received by the receiver via communication between the receiver and an IC card or a terminal device storing this attribute information. The processor 38 of the control device 30 receives the attribute information received by the receiver.

In another example, when a user reserves a booth unit 10, attribute information of this user may be input and registered in reservation management information. In this case, the attribute information is sent from the management device 40 to the control device 30, and the processor 38 receives the attribute information.

For example, the attribute of a user is a dominant hand of the user. If the dominant hand of the user is the right hand, the projection device 16 projects an image on the first surface 18a. If the dominant hand of the user is the left hand, the projection device 16 projects an image on the third surface 22a. This projection control will be explained below.

If a user to input information into the digital whiteboard 14 is right-handed, he/she normally inputs information into the digital whiteboard 14 with the right hand. The user may input information into the digital whiteboard 14 while looking at an image projected by the projection device 16. It is easier for the right-handed user to face the left side than the right side while inputting information. When the user is inputting information into the digital whiteboard 14, he/she normally faces the digital whiteboard 14. Hence, based on the position of the user facing the digital whiteboard 14, the projection device 16 projects an image on the first surface 18a on the left side of the user rather than on the third surface 22a, which makes it easier for the user to look at the projected image while inputting information into the digital whiteboard 14.

If a user to input information into the digital whiteboard 14 is left-handed, the projection device 16 projects an image on the third surface 22a, which makes it easier for the user to look at the projected image while inputting information into the digital whiteboard 14.

### Second Example

In a second example, the digital whiteboard 14 is provided on the first surface 18a. As illustrated in FIGS. 1 through 3, the second surface 20a and the third surface 22a are connected to each other and one continuous surface is formed by the second surface 20a and the third surface 22a.

The projection device 16 projects an image on the second surface 20a and the third surface 22a under the control of the control device 30. For example, if the display size (length and width, for example) of an image to be projected is larger than or equal to a predetermined threshold, the projection device 16 projects the image on two surfaces (second surface 20a and third surface 22a, for example). The threshold is determined based on the size (length and width, for example) of each surface. If the display size of an image to be projected is larger than the size of one surface, the image is not contained within this surface. In the second example, to deal with such a case, the projection device 16 projects the image on two surfaces. Since one continuous surface is formed by the second surface 20a and the third surface 22a, even when an image is not contained within one surface, the entirety of the image can be projected on this continuous surface.

If the digital whiteboard 14 is provided on the third surface 22a, the projection device 16 projects an image on the first surface 18a and the second surface 20a.

### Third Example

In a third example, under the control of the control device 30, the projection device 16 projects information input into the digital whiteboard 14 on at least one of the first surface 18a, second surface 20a, and third surface 22a, which is not provided with the digital whiteboard 14.

For example, if the digital whiteboard 14 is provided on the second surface 20a, the projection device 16 projects information input into the digital whiteboard 14 on the first surface 18a or the third surface 22a, under the control of the control device 30. The projection device 16 may project information input into the digital whiteboard 14 on both of the first surface 18a and the third surface 22a, under the control of the control device 30.

When information input into the digital whiteboard 14 is to be projected on at least one surface which is not provided with the digital whiteboard 14, the projection device 16 may start gradually projecting the information from the digital whiteboard 14. In this case, the projection device 16 may project an image indicating a position at which the information starts to be projected on at least one surface which is not provided with the digital whiteboard 14.

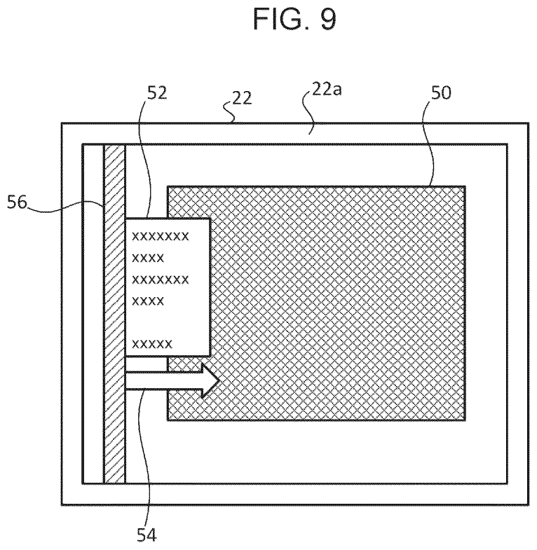

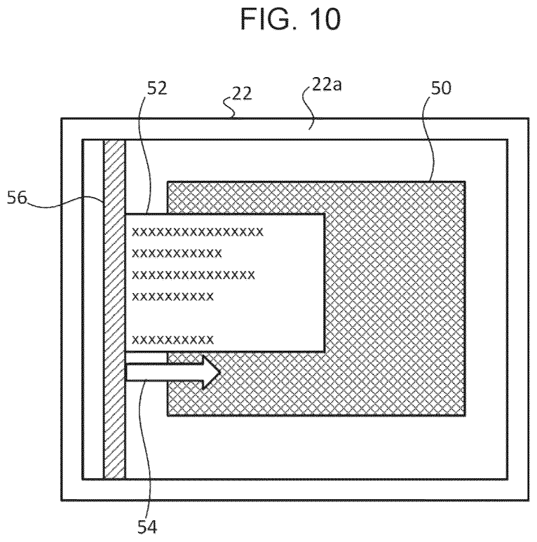

An example in which information input into the digital whiteboard 14 is projected will be discussed below with reference to FIGS. 9 and 10. FIGS. 9 and 10 illustrate the third surface 22a. Here, in one example, the digital whiteboard 14 is provided on the second surface 20a and information input into the digital whiteboard 14 is projected on the third surface 22a.

As illustrated in FIGS. 9 and 10, an image 50 is projected on the third surface 22a. The image 50 is not an image representing information input into the digital whiteboard 14, but an image received by the control device 30 as an image to be projected.

When information is input into the digital whiteboard 14, the projection device 16 projects the information on the third surface 22a under the control of the control device 30. For example, the projection device 16 projects an image 52 representing information input into the digital whiteboard 14 on the third surface 22a. In this case, the projection device 16 may project the image 52 by superimposing it on the image 50.

The projection device 16 starts gradually projecting the image 52 in a direction from the second surface 20a provided with the digital whiteboard 14 to the third surface 22a. In the example in FIG. 9, the second surface 20a is formed on the left side of the third surface 22a, and the projection device 16 starts gradually projecting the image 52 from the left side of the third surface 22a to the right side thereof. As shown in FIG. 10, the projection device 16 projects the image 52 on the third surface 22a in a direction indicated by the arrow 54 in accordance with the lapse of time. In this manner, the projection device 16 gradually shifts the image 52 from the left side to the right side of the third surface 22a.

The projection device 16 also projects on the third surface 22a an image 56 at a position at which the image 52 starts to be projected. The image 56 is an image representing the position at which the image 52 starts to be projected and is displayed differently from the other images. For example, the image 56, which is an image highlighted in color or with brightness different from that of the other images, is displayed. This enables a user using the booth unit 10 to recognize the position from which the image 52 starts to be displayed.

In the example in FIGS. 9 and 10, an explanation is given of an example in which the digital whiteboard 14 is provided on the second surface 20a and an image is projected on the third surface 22a. However, this is only an example. Even in a case in which the digital whiteboard 14 is provided on a surface other than the second surface 20a, the above-described processing in the third example can be executed similarly.

### Fourth Example

In a fourth example, the projection device 16 projects an image on two of the first surface 18a, second surface 20a, and third surface 22a, which are not provided with the digital whiteboard 14. For example, one of these two surfaces is set to a first projection screen, and the other surface is set to a second projection screen. The projection device 16 projects a first image representing first information on the first projection screen and a second image representing second information on the second projection screen.

For example, when a user selects the first information as information to be projected, the projection device 16 projects the first image representing the first information on the first projection screen. The processor 38 of the control device 30 obtains second information related to the first information and the projection device 16 projects the second image representing the second information on the second projection screen.

The second information is information related to the first information. For instance, the first information and the second information are files, such as data files. If the first information is video image data, audio data obtained together with the video image data is the second information. If the first information is computer-aided design (CAD) data, data on a developed diagram of the object indicated by the CAD data is the second information. If the first information is processed information, the second information may be the first information which has not yet been processed. For example, history information indicating a history of processing executed on the first information is linked with the first information, and the processor 38 of the control device 30 refers to the history information and obtains second information. Information created by a creator of the first information may be second information. Second information may be selected by a user.

The first projection screen and the second projection screen may be specified by a user or be determined in advance.

For example, the first information and the second information, which are files, are stored in an external device, such as a document management system or an image server, a terminal device of a user, or the control device 30. When the first information is selected by a user, the projection device 16 obtains the first information from an external device, for example, and projects the first image representing the first information on the first projection screen. The processor 38 of the control device 30 obtains the second information related to the first information from an external device, for example, and projects the second image representing the second information on the second projection screen.

The projection device 16 may project the second image included in the first image on the first projection screen. For example, a file of CAD data, for example, may include plural items of information to be projected. In this case, after the first information is selected from this file, the second information related to the first information is selected and the second image representing the second information is projected.

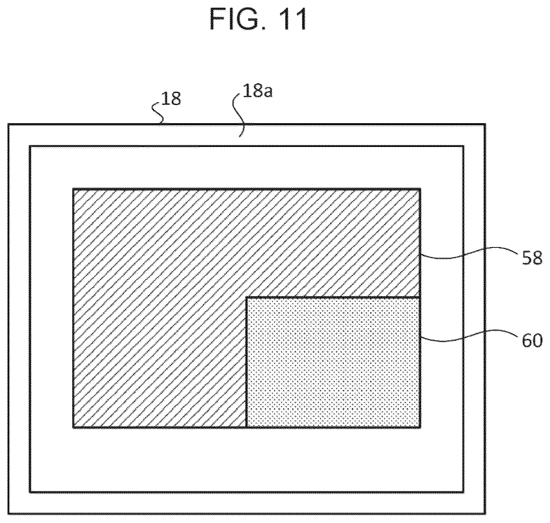

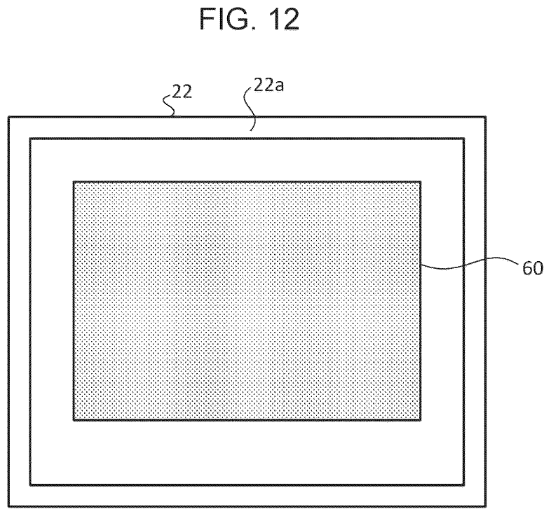

An example in which the second image included in the first image is displayed will be described below with reference to FIGS. 11 and 12. FIG. 11 illustrates the first surface 18a. FIG. 12 illustrates the third surface 22a. Here, in one example, the digital whiteboard 14 is provided on the second surface 20a, and the first surface 18a is the first projection screen, while the third surface 22a is the second projection screen.

For example, when an image 58 is selected by a user as an image to be projected, the projection device 16 projects the image 58 on the first surface 18a, as shown in FIG. 11. The image 58 is an example of the first image. The image 58 is an image representing the entirety of a certain device. The image 58 includes an image 60 indicating a component of this device. The image 60 is an example of the second image.

When the image 60 is selected by the user from the image 58 displayed on the first surface 18a, the projection device 16 projects the selected image 60 on the third surface 22a, as shown in FIG. 12. That is, the projection device 16 projects the image 60 included in the image 58 on the third surface 22a, which is a surface different from the first surface 18a on which the image 58 is displayed. In this manner, the projection device 16 projects the first image and the second image on different surfaces. The user can compare the first image and the second image on different surfaces. For example, the projection device 16 enlarges the image 60 and projects it on the third surface 22a. This enables the user to check details of the component represented by the image 60.

The projection device 16 may project the image 60 on the first surface 18a on which the image 58 is displayed, in accordance with the display size of each of the images 58 and 60 and the size of the component represented by the image 60. For example, if the images 58 and 60 are to be separately projected on the same surface without being superimposed on each other, the projection device 16 projects the images 58 and 60 on the same first surface 18a. In response to a user instruction, the projection device 16 may project the images 58 and 60 on the same first surface 18a or on different surfaces.

In the fourth example, the digital whiteboard 14 may not be included in the booth unit 10. That is, the fourth example may be carried out without the use of the digital whiteboard 14.

### Fifth Example

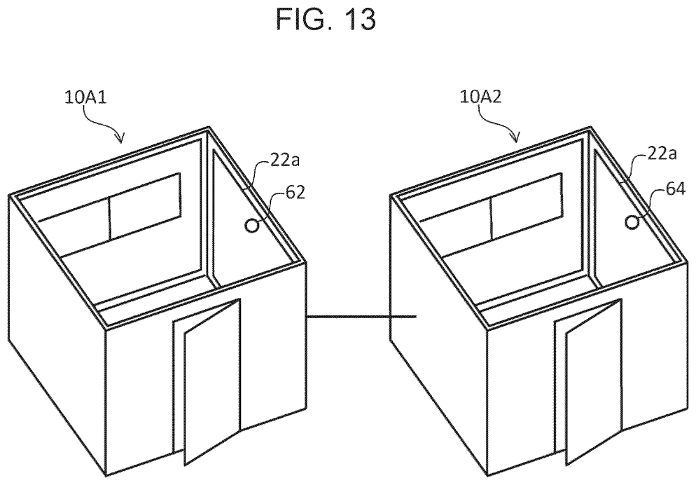

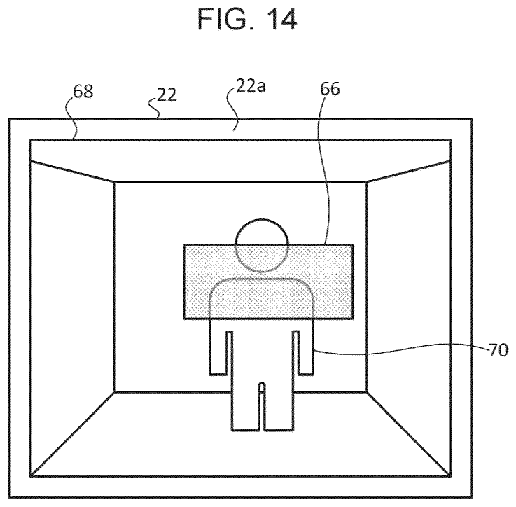

In a fifth example, the projection device 16 projects an image projected on a surface of another booth unit on at least one of the first surface 18a, second surface 20a, and third surface 22a. The fifth example will be described below with reference to FIGS. 13 and 14. FIG. 13 is a perspective view of booth units 10A1 and 10A2. FIG. 14 illustrates a surface of the booth unit 10A1.

Here, in one example, the booth unit 10A is used as a booth unit. When the booth unit 10 is used, processing is executed similarly to when the booth unit 10A is used.

The booth units 10A1 and 10A2 have the same configuration as that of the booth unit 10A. To distinguish the two booth units 10A shown in FIG. 13, one booth unit 10A is called the booth unit 10A1, while the other booth unit 10A is called the booth unit 10A2.

For the sake of description, the control device 30 provided in the booth unit 10A1 will be called a control device 301, while the control device 30 provided in the booth unit 10A2 will be called a control device 302. The processor 38 included in the control device 301 will be called a processor 381, while the processor 38 included in the control device 302 will be called a processor 382.

The control devices 301 and 302 communicate with each other via a communication channel so as to send and receive images and another type of information to and from each other. For example, the control device 301 receives a first image projected on a surface of the booth unit 10A2 from the control device 302, and the projection device 16 of the booth unit 10A1 projects the first image on a surface of the booth unit 10A1 under the control of the control device 301. In the booth unit 10A1, the surface on which the first image is projected is a surface on which the digital whiteboard 14 is not provided. In the booth unit 10A1, the surface on which the first image is projected may be a surface on which no image is projected.

For example, if, in the booth unit 10A1, the digital whiteboard 14 is provided on the second surface 20a and an image is projected on the first surface 18a, the first image is projected on the third surface 22a. The surface of the booth unit 10A1 on which the first image is to be projected may be specified by the user of the booth unit 10A1 or be determined in advance.

In the fifth example, the user of the booth unit 10A1 and the user of the booth unit 10A2 can share the first image projected on the surface of the booth unit 10A2.

Likewise, an image projected on a surface of the booth unit 10A1 may be projected on a surface of the booth unit 10A2.

A camera 62 may be provided on a surface of the booth unit 10A1 to image the inside of the booth unit 10A1. In the example shown in FIG. 13, the camera 62 is installed on the third surface 22a of the booth unit 10A1. However, this is only an example, the camera 62 may be provided on the first surface 18a or the second surface 20a. The camera 62 may be disposed on multiple surfaces or at another position, such as the ceiling.

A camera 64 may be provided on a surface of the booth unit 10A2 to image the inside of the booth unit 10A2. In the example shown in FIG. 13, the camera 64 is installed on the third surface 22a of the booth unit 10A2. However, this is only an example, the camera 64 may be provided on the first surface 18a or the second surface 20a. The camera 64 may be disposed on multiple surfaces or at another position, such as the ceiling.

A camera may be provided in only one of the booth units 10A1 and 10A2.

For instance, the control device 301 of the booth unit 10A1 receives a second image captured by the camera 64 from the control device 302 of the booth unit 10A2. The projection device 16 of the booth unit 10A1 projects the second image on a surface of the booth unit 10A1 under the control of the control device 301. The surface of the booth unit 10A1 on which the second image is to be projected is a surface which is not provided with the digital whiteboard 14. The surface of the booth unit 10A1 on which the second image is to be projected may be a surface on which no image is projected.

The projection device 16 of the booth unit 10A1 may project the second image by superimposing it on the first image, under the control of the control device 301. For example, projection device 16 of the booth unit 10A1 projects the first image on the third surface 22a and the second image on the same third surface 22a by superimposing it on the first image. If a human is included in the second image, translucent processing may be performed on a portion showing the human within the second image. Translucent processing may be performed by the control device 301 or 302. The transparency level in translucent processing may be specified by the user of the booth unit 10A1 or 10A2 or be preset.

FIG. 14 illustrates an example of the superimposition display of a first image and a second image. In FIG. 14, the third surface 22a of the booth unit 10A1 is shown. Here, in one example, the projection device 16 of the booth unit 10A1 projects a first image 66 on the third surface 22a. For example, the first image 66 is an image which is projected on a surface (first surface 18a, for example) of the booth unit 10A2. The projection device 16 of the booth unit 10A1 projects a second image 68 by superimposing it on the first image 66 on the third surface 22a. The second image 68 is an image captured by the camera 64 provided on the third surface 22a of the booth unit 10A2. The second image 68 shows the inside of the booth unit 10A2. The second image 68 also shows a human 70 who is in the booth unit 10A2. Translucent processing has been executed on the image of the human 70.

The first image 66 may be an image selected by the user of the booth unit 10A2 or an image selected by the user of the booth unit 10A1. That is, when the first image 66 is being projected on a surface of the booth unit 10A1, the right to switch the first image 66 may be possessed by either one of the user of the booth unit 10A2 and the user of the booth unit 10A1.

Reverse processing for reversing the left and right sides of the image of the human 70 may be executed. Reverse processing may be executed by the control device 301 or 302. The orientation of the camera 64 is opposite the orientation of the projection device 16 of the booth unit 10A2. If the image of the human 70 is superimposed on the first image 66 without reversing the left and right sides of this image, the left-right direction of the human 70 and that of the first image 66 become opposite. Accordingly, a position pointed by the human 70 in the booth unit 10A2 is displayed at the horizontally reversed position in the second image 68 displayed in the booth unit 10A1. The user in the booth unit 10A1 may feel unnatural. If the image of the human 70 is superimposed on the first image 66 by reversing the left and right sides of this image, the left-right direction of the human 70 and that of the first image 66 match each other, which makes the user in the booth unit 10A1 comfortable.

The control device 301 of the booth unit 10A1 may send an image projected on a surface of the booth unit 10A1 on which the first image 66 is not projected to the booth unit 10A2 and the control device 302 may cause the projecting device 16 to project the image on a surface of the booth unit 10A2. For example, the image projected on the first surface 18a of the booth unit 10A1 is sent from the booth unit 10A1 to the booth unit 10A2 and is projected on the third surface 22a of the booth unit 10A2.

Additionally, an image captured by the camera 62 of the booth unit 10A1 may be sent to the booth unit 10A2 and be projected on a surface of the booth unit 10A2.

In the fifth example, the digital whiteboard 14 may not be included in the booth unit 10. That is, the fifth example may be carried out without the use of the digital whiteboard 14.

A system may be formed by the booth units 10A1 and 10A2. Three or more booth units 10A may form a system. The sizes and the shapes of booth units included in the system may be the same or be different from each other. The system may be formed by a booth unit 10 and a booth unit 10A.

### Sixth Example

The projection device 16 may project an image on a surface based on the size of this image under the control of the control device 30.

For example, information on the size of an image is appended to the image. The processor 38 of the control device 30 selects the surface on which the image is to be displayed, based on information on the sizes of the surfaces among the first surface 18a, second surface 20a, and third surface 22a, which are not provided with the digital whiteboard 14, and information on the size of the image to be projected. Information on the sizes of the surfaces is prestored in the memory 36 of the control device 30. For example, the processor 38 selects a surface on which the image can be displayed in full scale. The projection device 16 projects the image on the surface selected by the processor 38.

CAD data, for example, includes figure information on the size of a figure and various other information, such as specification information and design information. The processor 38 refers to these items of information, identifies the size of an image represented by CAD data, and selects the surface on which the image is to be projected.

### Seventh Example

In a seventh example, the booth unit 10 includes a microphone. The microphone collects voice in the booth unit 10. The processor 38 of the control device 30 analyzes the voice collected by the microphone and creates a character string representing the content of the voice. A known technique is used for analyzing the voice and creating a character string from the analyzed voice. The projection device 16 projects the created character string on at least one surface of the booth unit 10 under the control of the control device 30. For example, if the digital whiteboard 14 is provided on the second surface 20a, the character string is projected on at least one of the first surface 18a and the third surface 22a. The surface on which the character string is to be projected may be specified by a user or be determined in advance.

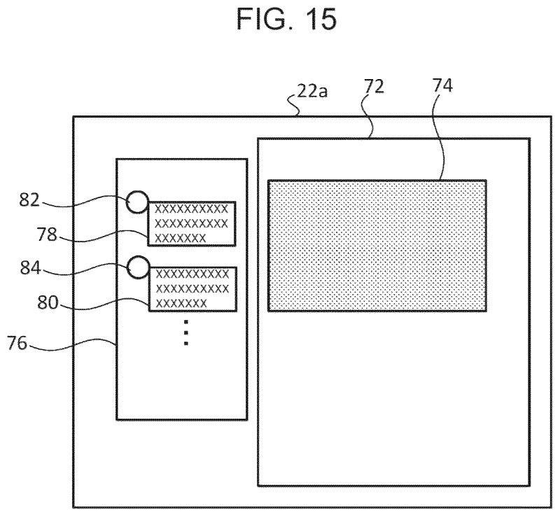

A display example of a character string representing the content of voice is shown in FIG. 15. FIG. 15 illustrates the third surface 22a of the booth unit 10. Here, in one example, an image 72 is projected on the third surface 22a. The image 72 includes an image 74 representing a document, such as a material document.

The projection device 16 projects a list 76 of character strings on the third surface 22a. The list 76 includes one or plural character strings. Here, in one example, character strings 78, 80, . . . are included in the list 76. The character strings 78, 80 . . . are character strings representing the content of voice collected by the microphone. The processor 38 of the control device 30 arranges the character strings 78, 80, . . . in chronological order in which the voice is collected and causes the projection device 16 to project the character strings 78, 80 . . . on the third surface 22a.

The processor 38 may recognize a user having said something from his/her voice, link an image (such as an icon or a thumbnail image) of this user to a character string representing what the user has said, and cause the projection device 16 to project the character string. The image of the user is an image of the face of the user or an image indicating the name or account name of the user. A known recognition technique is used for recognizing the user having said something. For example, voice data indicating the voices of users is stored in the memory 36 and the processor 38 refers to this voice data and recognizes the user having said something.

In the example in FIG. 15, an image 82 is linked with the character string 78 and is projected, while an image 84 is linked with the character string 80 and is projected. More specifically, the image 82 is projected near the character string 78, while the image 84 is projected near the character string 80. The image 82 is an image of a user having uttered words represented by the character string 78. The image 84 is an image of a user having uttered words represented by the character string 80.

If the voice that matches a registered keyword is collected, the processor 38 may cause the projection device 16 to project a character string representing the content of voice that is collected around a time at which the voice matching the keyword is given. The length of time for which the voice is collected may be preset or be set by a user.

The processor 38 may identify a facing direction of a user having said something and the projection device 16 may project a character string representing what the user has said on the surface leading to the facing direction of the user. For example, a user is imaged by a camera provided in the booth unit 10 and the processor 38 analyzes the image captured by the camera and identifies the facing direction of the user (the line of sight or the face direction of the user, for example). The projection device 16 then projects a character string representing what the user has said on the surface leading to the identified facing direction of the user.

For example, if a user having said something is looking at the first surface 18a, the projection device 16 projects a character string representing what the user has said on the first surface 18a.

If a user has said something by looking at the first surface 18a and then has said something by looking at the third surface 22a, the projection device 16 projects a character string representing what the user has said on the first surface 18a and then projects a character string representing what the user has said on the third surface 22a. When the character string representing what the user has said is projected on the third surface 22a, the projection device 16 may project the character string projected on the first surface 18a on the third surface 22a or may not project it on the third surface 22a.

The projection device 16 may project a character string representing the content of voice of a user on a specific surface regardless of the facing direction of the user. For example, the projection device 16 projects a character string representing the content of voice of the user on the third surface 22a. In this case, under the control of the control device 30, the projection device 16 projects the character string on the third surface 22a in a display mode in accordance with the facing direction of the user. For example, the projection device 16 projects the character string on the third surface 22a in a display mode in which the facing direction of the user can be identified. Examples of the display mode are the color, font type, and size of characters and decorations for characters.

For example, if a user has said something by looking at the first surface 18a, the projection device 16 projects a character string representing what the user has said in red on the third surface 22a. If a user has said something by looking at the second surface 20a, the projection device 16 projects a character string representing what the user has said in blue on the third surface 22a. In this manner, the character string representing what the user has said while looking at the first surface 18a and the character string representing what the user has said while looking at the second surface 20a can be distinguished from each other. With this arrangement, when a user looks at a character string, which represents what another user has said, projected on the third surface 22a, he/she can recognize in which direction this user was facing while speaking. In addition to or instead of changing the color of characters, the processor 38 may change the font type or the size of characters or decorations for the characters.

When a user has said something by facing a specific direction, the projection device 16 may project a character string representing what the user has said on a certain surface (third surface 22a, for example). When a user has said something by facing a direction other than the specific direction, the projection device 16 may not necessarily project a character string representing what the user has said on a certain surface (third surface 22a, for example). For example, when a user has said something by looking at the first surface 18a, the projection device 16 projects a character string representing what the user has said on the third surface 22a. When a user has said something by looking at a surface other than the first surface 18a, the projection device 16 does not project a character string representing what the user has said on the third surface 22a.

The projection device 16 may project a character string representing what a user has said on the nearest surface for this user. For example, this user and the surfaces of the booth unit 10 are imaged by a camera provided in the booth unit 10, and based on the image captured by the camera, the processor 38 calculates the distance between the user and each surface and identifies the nearest surface for the user. The projection device 16 then projects a character string representing what the user has said on the nearest surface.

### Eighth Example

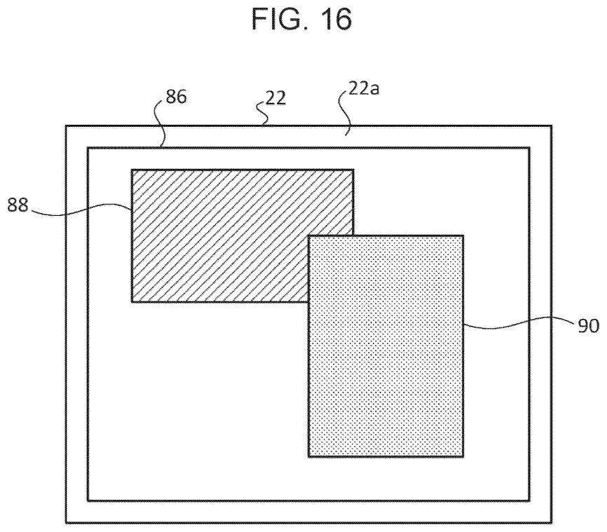

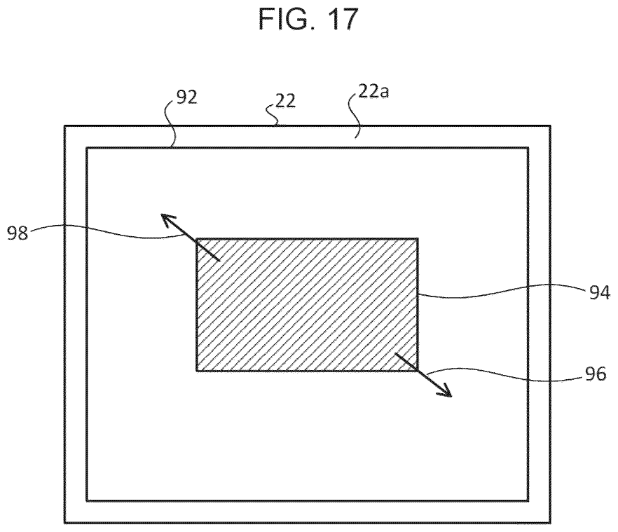

An example of operation performed on an image projected on a surface of the booth unit 10 will be described below with reference to FIGS. 16 and 17. FIGS. 16 and 17 illustrate the third surface 22a.

As illustrated in FIG. 16, an image 86 is projected on the third surface 22a. The image 86 includes images 88 and 90.

For example, a hand tracking sensor is provided in a booth unit 10 to detect the movement of a hand of a user. For example, a hand tracking sensor is provided in each of the first surface 18a, second surface 20a, and third surface 22a, and the processor 38 detects the movement of a hand based on detection results of the hand tracking sensors. A hand tracking sensor may be provided on a ceiling, a device on the ceiling, or a surface of the booth unit 10, for example.

It is now assumed that the image 90 is projected behind the image 88 and a user specifies the image 90 on the third surface 22a. In this case, in response to the specifying operation of the user, the projection device 16 projects the image 90 on top of the image 88. The position at which an image is projected may be changed in accordance with the movement of a hand. The processor 38 may switch the image to be projected in accordance with the movement of a hand. When a user moves his/her hand from a certain surface (first surface 18a, for example) to another surface (second surface 20a, for example), the projection device 16 may shift the image projected on the first surface 18a to the second surface 20a and projects it on the second surface 20a.

FIG. 17 illustrates an example of enlarging operation of an image. An image 92 is projected on the third surface 22a. The image 92 includes an image 94. When a user moves his/her hand in directions in which the image 94 is enlarged, as indicated by arrows 96 and 98, for example, the projection device 16 enlarges the image 94 and projects it on the third surface 22a. When the user moves his/her hand in directions in which the image 94 shrinks, the projection device 16 shrinks the image 94 and projects it on the third surface 22a.

### Ninth Example

In a ninth example, when a user having made a reservation for a booth unit 10 is authenticated for using the booth unit 10, the processor 38 of the control device 30 powers ON the projection device 16.

As discussed above, reservations for a booth unit 10 may be managed by the management server 40 or the control device 30 of the booth unit 10. For example, when a user has made a reservation for a booth unit 10, reservation information about this reservation is stored in the memory 36 of the control device 30. The reservation information includes user identification information for identifying the user having made the reservation, information indicating the reserved date and time, and other information.

For example, a camera is installed outside the booth unit 10 and captures an image of a person around the booth unit 10 and a person approaching the booth unit 10. The processor 38 of the control device 30 recognizes a person around the booth unit 10 and a person approaching the booth unit 10, based on images captured by the camera. A known technique is used for recognizing such persons. The processor 38 determines whether a recognized person is the user having made a reservation for the booth unit 10, based on a recognition result and the user identification information stored in the memory 36. More specifically, the processor 38 obtains from the memory 36 reservation information about a reservation whose reservation period is included in a time period around the time at which the recognition result was obtained (imaging time of the person approaching the booth unit 10), and checks the user identification information included in the reservation information against the recognition result. If the user identification information of the person recognized by the camera is included in the reservation information and is stored in the memory 36, authentication for this person succeeds. If authentication succeeds, the processor 38 powers ON the projection device 16. The processor 38 may power ON other devices, such as a speaker and lighting. As user authentication, authentication using an IC card and authentication using biological information (that is, biometric authentication) may be used.

Settings information (information about the volume of the speaker, for example) which was used when a user used the booth unit 10 last time may be stored in the memory 36. In this case, the processor 38 may set settings for various devices in advance in accordance with the settings information. For example, the processor 38 may set such settings before the user enters the booth unit 10.

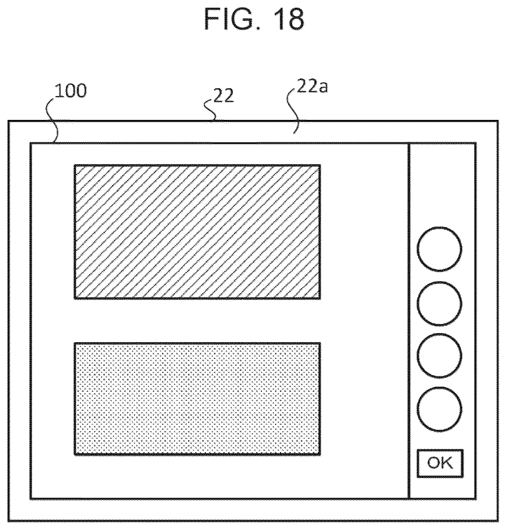

The image projected most recently when the booth unit 10 was used last time may be stored in the memory 36. In this case, the projection device 16 may project this image on a surface of the booth unit 10 under the control of the control device 30. For example, the projection device 16 projects the image on a surface of the booth unit 10 before the user enters it. The projection device 16 may project the image on the same surface as that for the last time. An example of such a case is shown in FIG. 18. For instance, the projection device 16 projects an image 100 on the same third surface 22a as that for the last time.

The processor 38 may start application software which was used when the booth unit 10 was used last time.

The processor 38 may perform user authentication when a user is approaching the booth unit 10, and if, authentication succeeds, the processor 38 may power ON the projection device 16. Then, when the user enters the booth unit 10, the processor 38 may cause the projection device 16 to project the previously used image on a surface of the booth unit 10.

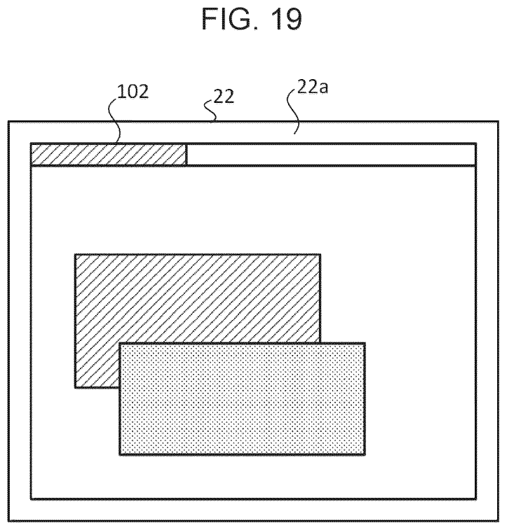

Under the control of the control device 30, the projection device 16 may project information about the remaining time of a reservation period for using the booth unit 10 on a surface of the booth unit 10. An example in which the remaining time is displayed is shown in FIG. 19. FIG. 19 illustrates the third surface 22a. The projection device 16 projects an image 102 indicating the start time and the end time of a reservation period on the third surface 22a. The image 102 shows the remaining time, as in an indicator, for example.

### Second Exemplary Embodiment

An information processing apparatus according to a second exemplary embodiment will be described below.

The information processing apparatus according to the second exemplary embodiment includes a communication unit, a UI, a memory, and a processor, for example. The information processing apparatus may be a terminal device or may be the control device 30 of the first exemplary embodiment.

The processor of the information processing apparatus according to the second exemplary embodiment links a first file image and a first user image with each other and displays them. The first file image represents a file linked with an account of a first user. The first user image represents the first user. The processor also links a second file image and a second user image with each other and displays them, together with the first file image and the first user image. The second file image represents a file linked with an account of a second user, who is different from the first user. The second user image represents the second user.

The files are document data, image data (such as still image data or video image data), or audio data. However, the files are not restricted to these types of data. The file format may be any type of format. The files may be stored in the information processing apparatus or be stored in an external device other than the information processing apparatus, such as a file server, a document management system, a user terminal of a user, or another server.

The file image is an icon or a thumbnail image of a file, for example. The user image, which is an image for identifying a user, is an image of the face of the user, an image representing the name, abbreviated name, or account name of the user (such as an image representing a character string), or an image representing a virtual character or an avatar. However, the user image is not restricted to these types of images.

The account is information used by a user to log in a service or a device. A login to a service or a device is a login to a cloud server, an online storage, a document management system, a file server, or a booth unit 10 or 10A, for example. For instance, an account is created for each user and is managed by a service providing device or a system. An account is created for each service or each device to which a user logs in. The accounts for the same user may be linked with each other and single sign-on may be implemented.

Displaying a file image and a user image may be displaying the file image and the user image on a display or may be causing a projection device to project them.

For example, the processor displays the first file image and the first user image on a display and also displays the second file image and the second user image on the same display.

When the first user image and the second user image are displayed together on a display and a user has selected one of them, the processor may display the file image linked with the selected user image on the display. In this case, the processor does not display the file image linked with the user image which is not selected by the user. For instance, when the first user image is selected, the processor displays the first file image on the display and does not display the second file image on the display.

In another example, the processor causes a projection device to project the first file image and the first user image and also to project the second file image and the second user image. For example, the projection device projects these images on the same projection surface. If the second exemplary embodiment is applied to the first exemplary embodiment, these images are projected on a surface inside the booth unit 10 or 10A.

The processor may display the first file image and the second file image so that they can be distinguished from each other. In one example, the processor displays the first file image and the second file image at different positions so that they can be distinguished from each other. In another example, the processor may display one of the first file image and the second file image. For instance, the processor displays the first user image and the second user image in a line, and when the first user image is selected, the processor displays the first file image and does not display the second file image. When the second user image is selected. the processor displays the second file image and does not display the first file image.

The processor may cause the projection device to project the first user image and the second user image together, and when one of the first and second user images is selected, the processor may cause the projection device to project the file image linked with the selected user image. In this case, the processor does not cause the projection device to project the file image linked with the user image which is not selected. For example, when the first user image is selected, the processor causes the projection device to project the first file image and does not cause the projection device to project the second file image.

The first file image includes an image representing a file linked with a first account of the first user and an image representing a file linked with a second account of the first user. The second account is an account different from the first account and is linked with the first account. For example, the first account is an account for logging in a certain service or device, while the second account is an account for logging in another service or device. The first account and the second account are linked with each other and are managed. As in the first file image, the second file image also includes images linked with individual different accounts.

For example, the first account is an account for using a specific place. Examples of the specific place are a booth unit 10, booth unit 10A, room, seat, meeting room, office, store, and another type of space. When the first user uses the specific place, the processor links the first file image and the first user image with each other and displays them. For example, when the first user uses the booth unit 10 or 10A, the processor links the first file image and the first user image with each other and causes the projection device 16 to project them. As a result, the first file image is projected on a surface inside the booth unit 10 or 10A.

For example, when authentication for a user for using the booth unit 10 or 10A succeeds, the processor links the first file image and the first user image with each other and causes the projection device 16 to project them. The first file image to be projected may be an image representing a file stored in a terminal device of the user or an image representing a file stored in another device, such as the control device 30 or an online storage.

When the second user uses the specific place together with the first user, the processor displays the second user image together with the first user image. For example, when the first user makes a reservation for the booth unit 10A, the account of the first user and that of the second user are registered in the management device 40. When authentication for the first user for using the booth unit 10A succeeds, the processor causes the projection device 16 to project the first user image and the second user image. In this manner, the user images of individual users using the booth unit 10A together are projected. When the first user image is selected, the processor causes the projection device 16 to project the first file image and does not cause the projection device 16 to project the second file image. When the second user image is selected, the processor causes the projection device 16 to project the second file image and does not cause the projection device 16 to project the first file image. Alternatively, the processor may cause the projection device 16 to project the first file image together with the second file image.

When projecting a file image on a surface of the booth unit 10 or 10A, under the control of the control device 30, the projection device 16 may project an image obtained from a file linked with an account of the first user on a certain surface (first surface 18a, for example) and an image obtained from another file linked with the account of the first user on another surface (third surface 22a, for example).

When the first user and the second user use the booth unit 10 or 10A together, under the control of the control device 30, the projection device 16 may project an image obtained from a file linked with an account of the first user on a certain surface (first surface 18a, for example) and an image obtained from a file linked with an account of the second user on another surface (third surface 22a, for example).

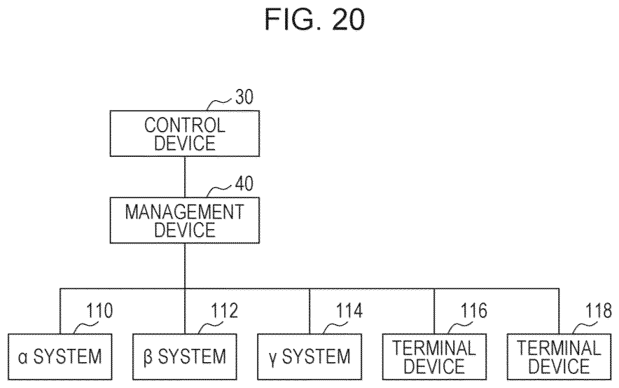

The second exemplary embodiment will be explained below through illustration of a specific example. An explanation will be given, assuming that processing of the second exemplary embodiment is executed at the booth unit 10 or 10A. However, this is only an example. Processing of the second exemplary embodiment may be executed when the booth unit 10 or 10A is not used. FIG. 20 is a block diagram illustrating an example of the configuration of the overall system of the second exemplary embodiment.

For example, the overall system of the second exemplary embodiment includes a control device 30, a management device 40, one or plural systems, and one or plural terminal devices. In the example in FIG. 20, the overall system includes an α system 110, a β system 112, a γ system 114, and terminal devices 116 and 118. The devices and systems included in the overall system communicate with each other via a communication channel, such as the internet or a LAN. For example, the control device 30 corresponds to an example of the information processing apparatus of the second exemplary embodiment.

Examples of the α system 110, β system 112, γ system 114 are an online storage, a document management system, a file server, and another server. Each system stores files.

The account of a user for using each of the α system 110, β system 112, γ system 114 is created and is registered therein. For example, different accounts for using the individual systems are created and registered therein. Each system manages files by account. For example, a user can log in the α system 110 by using the account for the α system 110. The user can also log in the other systems in a similar manner.

Examples of the terminal devices 116 and 118 are a PC, a tablet PC, a smartphone, and a mobile phone used by a user. For example, the terminal device 116 is a terminal device used by user A. The terminal device 118 is a terminal device used by user B. Files are stored in the terminal devices 116 and 118.

The account for using the booth unit 10 or 10A is registered in the management device 40 for each user. For example, a user makes a reservation for the booth unit 10 or 10A by using his/her account. The account is also used for authenticating the user at the booth unit 10 or unlocking the electronic lock provided on the door 28 of the booth unit 10A. The account for a booth unit may also be used to log in the management device 40 or a booth unit providing service provided by the management device 40.

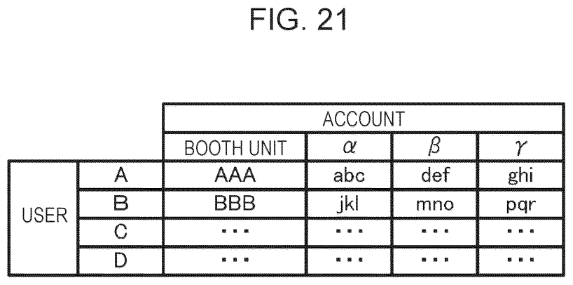

FIG. 21 illustrates an example of a management table for managing accounts of users. In FIG. 21, the accounts of each of user A, user B, user C, and user D are shown. For instance, for each user, the account for a booth unit, account for the α system 110, account for the β system 112, and account for the γ system 114 are associated with each other. The management table shown in FIG. 21 is stored in the control device 30, the management device 40, or another device, for example. Since the account for the booth unit is associated with the accounts for the individual systems in the management table, single sign-on using the account for the booth unit can be implemented. For example, when a user is authenticated at the booth unit 10 or 10A by using the account for the booth unit, he/she can automatically log in the α system 110, β system 112, γ system 114.

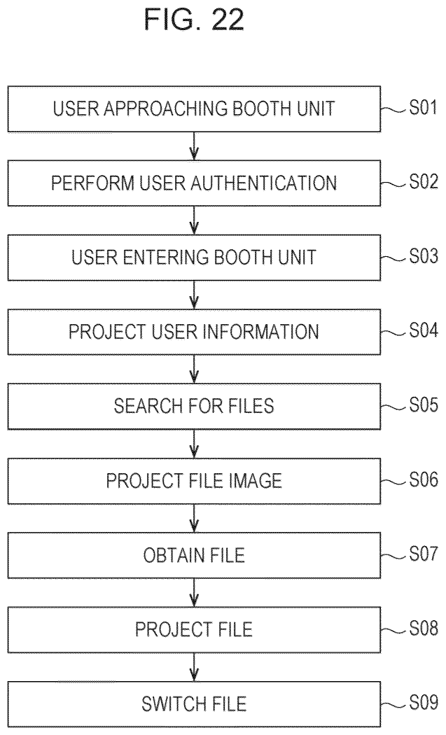

A processing procedure according to the second exemplary embodiment will be described below with reference to FIG. 22. FIG. 22 is a flowchart illustrating the processing procedure of the second exemplary embodiment. Here, in one example, a user uses a booth unit 10A.

First, in step S01, a user approaches the booth unit 10A. Then, in step S02, user authentication is performed. To perform user authentication, the account of the user for the booth unit is used, for example. As discussed in the first exemplary embodiment, user authentication may be performed by using an image of the user captured by a camera provided in the booth unit 10A, or authentication using an IC card or biometric authentication may be performed. When user authentication succeeds, the electronic lock of the door 28 is unlocked. The processor 38 of the control device 30 recognizes the user verified by this user authentication. When user authentication succeeds, logging in to the control device 30 and the management device 40 or a service provided by the management device 40 is completed. This can implement single sign-on to the α system 110, β system 112, γ system 114.

When the user enters the booth unit 10A, the entry of the user is detected in step S03. For example, the user is detected by a motion sensor provided in the booth unit 10A.

The processor 38 of the control device 30 collects information of the user logged in the booth unit 10A and causes the projection device 16 to project the information in step S04. The information of the user is a user image or another type of user identification information, for example.

In step S05, the processor 38 searches for files linked with the account of the user for the booth unit. For example, the processor 38 searches each of the α system 110, β system 112, γ system 114 for files linked with the account of the user.

In step S06, the projection device 16 projects a file image, such as an icon or a thumbnail image of a file, representing a file searched for in step S05 on a surface (at least one of the first surface 18a, second surface 20a, and third surface 22a) inside the booth unit 10A. The file image may be created by the processor 38 of the control unit 30 or by a device or a system (α system 110, β system 112, and γ system 114, for example). The projection device 16 projects a thumbnail image of each file on a surface inside the booth unit 10A. The processor 38 may cause the projection device 16 to project a thumbnail image of a file stored in a terminal device (terminal device 116, for example) used by the user.

If multiple file images are projected, in response to selecting of one of the file images by the user, the processor 38 obtains the file corresponding to the selected file image from the system or the terminal device 116 storing this file in step S07.

The projection device 16 projects the file obtained in step S07 on a surface inside the booth unit 10A in step S08. For example, if the file is document data, the projection device 16 projects the content of the document data on a surface inside the booth unit 10A.

If the user switches the file to be projected, the processor 38 obtains the corresponding file and the projection device 16 projects the file obtained in step S09.

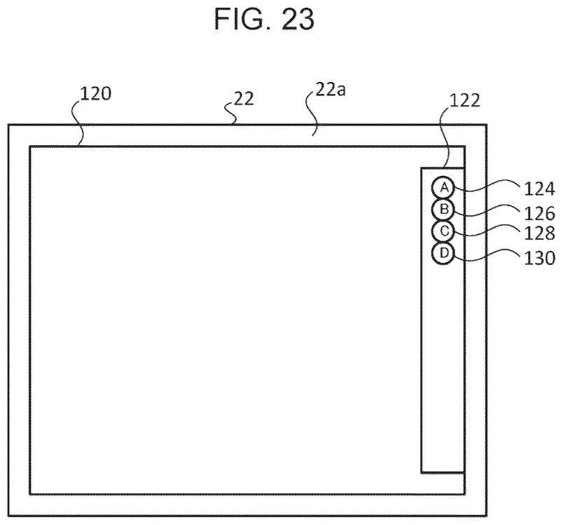

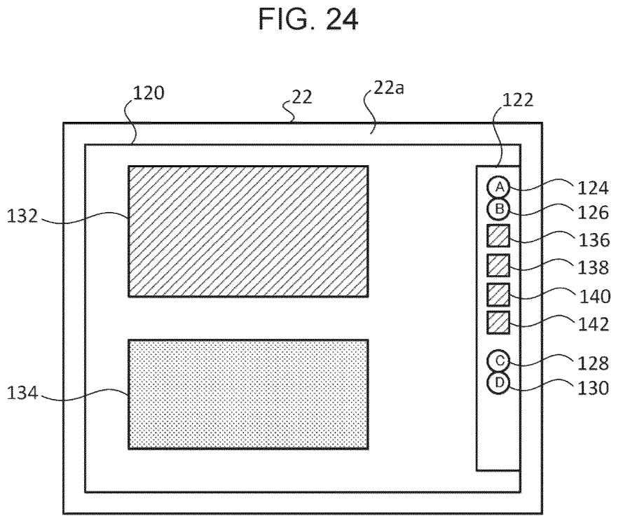

A display example of user images and file images will be explained below with reference to FIGS. 23 and 24. FIGS. 23 and 24 show the third surface 22a of the booth unit 10A.

An explanation will be given, assuming that user A, user B, user C, and user D use the booth unit 10A together by way of example.

For example, user A makes a reservation for the booth unit 10A. Then, reservation information including the account of user A for the booth unit and information indicating the usage time of the booth unit 10A is registered in the management device 40. The reservation information may be sent from the management device 40 to the control device 30 and be stored in the memory 36 of the control device 30, and this reservation may be managed by the control device 30.

When making a reservation, user A may register user A, user B, user C, and user D in the management device 40 as users using the booth unit 10A. As a result, the account of each of user A, user B, user C, and user D for using the booth unit is linked with the reservation and is included in the reservation information, together with information indicating the usage time of the booth unit 10A. The resulting reservation information is then registered in the management device 40. In this example, too, the reservation information may be sent from the management device 40 to the control device 30 and be stored in the memory 36 of the control device 30, and this reservation may be managed by the control device 30.

User authentication is performed when user A, user B, user C, or user D uses the booth unit 10A. If user authentication succeeds, the entry of this user to the booth unit 10A is allowed. User authentication may be performed only for user A or all of user A, user B, user C, and user D.

Here, in one example, it is assumed that user authentication is performed for each of user A, user B, user C, and user D. If user authentication for each of user A, user B, user C. and user D succeeds, single sign-on is implemented. This allows each of user A, user B, user C, and user D to access to the α system 110, β system 112, and γ system 114 via the control device 30.

When user authentication for each of user A, user B, user C, and user D succeeds, the projection device 16 projects the user image of each of user A, user B, user C, and user D on the third surface 22a under the control of the control device 30. In FIG. 23, an overall image 120 is projected on the third surface 22a. The overall image 120 includes a display region 122. The display region 122 is a region where a user image and a file image of an authenticated user are projected.

Since user authentication for each of user A, user B, user C, and user D has succeeded, a user image 124 representing user A, user image 126 representing user B, user image 128 representing user C, and user image 130 representing user D are projected on the display region 122. In one example, the user images 124, 126, 128, and 130 are aligned vertically. However, this display example is only an example. Multiple user images may be projected in plural columns vertically or in one or plural rows horizontally.

It is assumed that user A, user B, user C, and user D are registered in the management device 40 when the booth unit 10A is reserved. In this case, if user authentication for user A succeeds, the user image of each of user A, user B, user C, and user D may be projected on the third surface 22a without performing user authentication for user B, user C, and user D.

For example, when a user selects one of the user images 124, 126, 128, and 130, the processor 38 searches for files linked with the account of the user represented by the selected user image. The projection device 16 projects a file image representing a searched file on the third surface 22a under the control of the control device 30. For example, the processor 38 searches the α system 110, β system 112, and γ system 114 for files. The processor 38 may search the terminal device of the user represented by the selected user image for files. A user image is selected as in the first exemplary embodiment. For example, operation for selecting a user image may be detected with a hand tracking sensor. Alternatively, a user may select a user image by operating the UI 34 of the control device 30 or by connecting the terminal device of the user to the control device 30 and by operating the UI of the terminal device.

When the user image 126 representing user B is selected, for example, the processor 38 searches the α system 110, β system 112, and γ system 114 for files linked with the account of user B. As discussed above, since single sign-on to the α system 110, β system 112, and γ system 114 is implemented, the processor 38 can access these systems and search for files linked with the account of user B. The processor 38 may search the terminal device of user B for files. The projection device 16 projects a file image representing a searched file on the third surface 22a.

A display example of file images is illustrated in FIG. 24. File images 136, 138, 140, and 142 are images representing the individual files linked with the account of user B. If, for example, the user image 126 is selected from the user images 124, 126, 128, and 130 arranged in a line in this order, the processor 38 forms a space between the selected user image 126 and the user image 128 displayed below and causes the projection device 16 to project the file images 136, 138, 140, and 142 in this space. With this operation, the file images 136, 138, 140, and 142 are projected so that they are linked with the user image 126 representing user B.

The processor 38 may cause the projection device 16 to project a file image of user B previously projected in the booth unit 10A. The processor 38 may cause the projection device 16 to project the file image representing the file that user B has most recently used with the account of user B for the α system 110. Likewise, the projection device 16 may project the file image representing the file that user B has most recently used with the account of user B for another system.

For example, the file image 136 is an image representing a file stored in the α system 110 and linked with the account of user B for the α system 110; the file image 138 is an image representing a file stored in the β system 112 and linked with the account of user B for the β system 112; the file image 140 is an image representing a file stored in the γ system 114 and linked with the account of user B for the γ system 114; and the file image 142 is an image representing a file stored in the terminal device of user B.

In the above-described example, user B is an example of the first user, and the file images 136, 138, 140, and 142 are examples of an image included in the first file image. For example, the account of user B for the α system 110 is the first account, while the account of user B for the β system 112 is the second account. The file image 136 is an example of the image representing the file linked with the first account of user B, who is the first user. The file image 138 is an example of the image representing the file linked with the second account of user B, who is the first user.

When one of the file images is selected by a user, the processor 38 obtains the file represented by the selected file image from α system or a device storing this file. The processor 38 starts a program for viewing or editing the obtained file and causes the projection device 16 to project the content of the file. As a result, the content of the file is projected on the third surface 22a. For example, if the file is document data, the content of the document is projected on the third surface 22a.

For example, if the file image 136 is selected, the processor 38 obtains the file represented by the file image 136 from the α system 110 and causes the projection device 16 to project the content of the file on the third surface 22a.

FIG. 24 illustrates that the content of a file is projected. For example, an image 132 is an image indicating the content of the file represented by the file image 136, while an image 134 is an image indicating the content of the file represented by the file image 138.

In the state shown in FIG. 24, when the user image 124 representing user A is selected, the processor 38 searches for files linked with the account of user A in a manner similar to searching for files of user B. The processor 38 forms a space between the selected user image 124 representing user A and the user image 126 representing user B and causes the projection device 16 to project file images of searched files in this space. When one of the file images is selected, the projection device 16 projects an image representing the content of the file represented by the selected file image on the third surface 22a. The projection device 16 may project the image representing the content of the file, together with the images 132 and 134. As a result, the content of a file linked with one user and that linked with another user are projected on the same third surface 22a. Alternatively, the image representing the content of a file linked with the account of user A may be projected on a surface different from the third surface 22a (first surface 18a, for example). In another example, when the file image representing a file linked with the account of user A is selected, the projection device 16 may stop projecting the images 132 and 134 on the third surface 22a.

When the user image 124 representing user A is selected, the processor 38 deletes the space between the user image 126 representing user B and the user image 128 representing user C and causes the projection device 16 to stop projecting the file images 136, 138, 140, and 142. As a result, only file images linked with the account of user A are projected on the third surface 22a. Alternatively, even when the user image 124 is selected, the file images 136, 138, 140, and 142 may remain displayed. In this state, when the user image 126 is selected, the space between the user images 126 and 128 may be deleted, and the projection device 16 may stop displaying the file images 136, 138, 140, and 142. When another user image is selected, processing is executed similarly.

The processor 38 may cause the projection device 16 to project a file image representing a file linked with the account of user A, a file image representing a file linked with the account of user B, a file image representing a file linked with the account of user C. and a file image representing a file linked with the account of user D so that these file images are arranged in a line on the display region 122.

For example, the projection device 16 projects a file image representing a file linked with the account of user A between the user images 124 and 126. The projection device 16 projects a file image representing a file linked with the account of user B between the user images 126 and 128. The projection device 16 projects a file image representing a file linked with the account of user C between the user images 128 and 130. The projection device 16 projects a file image representing a file linked with the account of user D below the user image 130. In this manner, a file image representing a file linked with the account of each user may be projected.

The projection device 16 may project an image representing the content of a file linked with one account of a user on one surface and project an image representing the content of a file linked with another account of this user on another surface. For example, the projection device 16 projects the image 132 representing the content of one file on the third surface 22a and projects the image 134 representing the content of another file on a surface other than the third surface 22a (first surface 18a, for example).

Additionally, the projection device 16 may project an image representing the content of a file linked with the account of one user on one surface and an image representing the content of a file linked with the account of another user on another surface. It is now assumed that a file image representing a file linked with the account of user A and a file image representing a file linked with the account of user B are selected. In this case, the projection device 16 projects the image representing the content of the file linked with the account of user A on the first surface 18a and projects the image representing the content of the file linked with the account of user B on the third surface 22a. With this arrangement, when another user views files projected on different surfaces, he/she can identify to whom these files belong.

The configurations of the overall systems according to the first and second exemplary embodiments are only examples. The overall system of each of the first and second exemplary embodiments may be configured in any manner if processing of the corresponding exemplary embodiment is executed in the overall system as a whole. That is, some or all of the functions of the control device 30 may be executed by the management device 40, a terminal device, or another device, and some or all of the functions of the management device 40 may be executed by the control device 30, a terminal device, or another device.

If some of the functions of the control device 30 are executed by another device, the control device 30 and this device may form an information processing system. That is, the functions of the control device 30 may be implemented by a single device or by an information processing system including plural devices.

Likewise, if some of the functions of the management device 40 are executed by another device, the management device 40 and this device may form an information processing system. That is, the functions of the management device 40 may be implemented by a single device or by an information processing system including plural devices.

In one example, the functions of the control device 30 and those of the management device 40 are implemented by collaboration of hardware and software. For example, as a result of the processor 38 of the control device 30 reading a program stored in a memory and executing it, the functions of the control device 30 are implemented. The program is stored in the memory as a result of being recorded in a recording medium, such as a compact disc (CD) or a digital versatile disc (DVD) or being received via a communication channel, such as a network. Likewise, as a result of the processor 48 of the management device 40 reading a program stored in a memory and executing it, the functions of the management device 40 are implemented. The program is stored in the memory as a result of being recorded in a recording medium, such as a CD or a DVD or being received via a communication channel, such as a network.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system comprising:
a processor configured to:
   link a first file image with a first user image and display the first file image and the first user image, the first file image representing a file linked with an account of a first user, the first user image representing the first user; and
   link a second file image with a second user image and display the second file image and the second user image together with the first file image and the first user image, the second file image representing a file linked with an account of a second user, the second user image representing the second user, the second user being different from the first user.
      (((2)))

The information processing system according to (((1))), wherein:
the first file image includes an image representing a file linked with a first account of the first user and an image representing a file linked with a second account of the first user; and
the second account is an account different from the first account and linked with the first account.
   (((3)))

The information processing system according to (((2))), wherein:
the first account is an account for using a specific place; and
the processor is configured to link the first file image with the first user image and display the first file image and the first user image when the first user uses the specific place.
   (((4)))

The information processing system according to (((3))), wherein the processor is configured to display the second user image together with the first user image when the second user uses the specific place together with the first user.

(((5)))

The information processing system according to (((4))), wherein the processor is configured to display the first file image and the second file image in such a manner that the first file image and the second file image are distinguished from each other.

(((6)))

The information processing system according to (((5))), wherein the processor is configured to:
display the first user image and the second user image in a line; and
display the first file image and does not display the second file image when the first user image is selected.
   (((7)))

The information processing system according to (((3))), further comprising:
a projection device that projects an image on a surface of at least one of a plurality of walls, the plurality of walls surrounding at least part of the specific place,
wherein the projection device projects an image representing content of a file linked with the account of the first user on a surface of a first wall of the plurality of walls and projects an image representing content of another file linked with the account of the first user on a surface of a second wall of the plurality of walls, the second wall being a wall different from the first wall.
   (((8)))

The information processing system according to (((3))), further comprising:
a projection device that projects an image on a surface of at least one of a plurality of walls, the plurality of walls surrounding at least part of the specific place,
wherein the projection device projects an image representing content of a file linked with the account of the first user on a surface of a first wall of the plurality of walls and projects an image representing content of a file linked with the account of the second user on a surface of a second wall of the plurality of walls, the second wall being a wall different from the first wall.
   (((9)))

A program causing a computer to execute a process, the process comprising:
linking a first file image with a first user image and displaying the first file image and the first user image, the first file image representing a file linked with an account of a first user, the first user image representing the first user; and
linking a second file image with a second user image and displaying the second file image and the second user image together with the first file image and the first user image, the second file image representing a file linked with an account of a second user, the second user image representing the second user, the second user being different from the first user.

What is claimed is:

1. An information processing system comprising:
a processor configured to:
link a first file image with a first user image and display the first file image and the first user image, the first file image representing a file linked with an account of a first user, the first user image representing the first user; and
link a second file image with a second user image and display the second file image and the second user image together with the first file image and the first user image, the second file image representing a file linked with an account of a second user, the second user image representing the second user, the second user being different from the first user.

2. The information processing system according to claim 1, wherein:
the first file image includes an image representing a file linked with a first account of the first user and an image representing a file linked with a second account of the first user; and
the second account is an account different from the first account and linked with the first account.

3. The information processing system according to claim 2, wherein:
the first account is an account for using a specific place; and
the processor is configured to link the first file image with the first user image and display the first file image and the first user image when the first user uses the specific place.

4. The information processing system according to claim 3, wherein the processor is configured to display the second user image together with the first user image when the second user uses the specific place together with the first user.

5. The information processing system according to claim 4, wherein the processor is configured to display the first file image and the second file image in such a manner that the first file image and the second file image are distinguished from each other.

6. The information processing system according to claim 5, wherein the processor is configured to:
display the first user image and the second user image in a line; and
display the first file image and does not display the second file image when the first user image is selected.

7. The information processing system according to claim 3, further comprising:
a projection device that projects an image on a surface of at least one of a plurality of walls, the plurality of walls surrounding at least part of the specific place,
wherein the projection device projects an image representing content of a file linked with the account of the first user on a surface of a first wall of the plurality of walls and projects an image representing content of another file linked with the account of the first user on a surface of a second wall of the plurality of walls, the second wall being a wall different from the first wall.

8. The information processing system according to claim 3, further comprising:
a projection device that projects an image on a surface of at least one of a plurality of walls, the plurality of walls surrounding at least part of the specific place,
wherein the projection device projects an image representing content of a file linked with the account of the first user on a surface of a first wall of the plurality of walls and projects an image representing content of a file linked with the account of the second user on a surface of a second wall of the plurality of walls, the second wall being a wall different from the first wall.

9. An information processing method comprising:
linking a first file image with a first user image and displaying the first file image and the first user image, the first file image representing a file linked with an account of a first user, the first user image representing the first user; and
linking a second file image with a second user image and displaying the second file image and the second user image together with the first file image and the first user image, the second file image representing a file linked with an account of a second user, the second user image representing the second user, the second user being different from the first user.

10. A non-transitory computer readable medium storing a program causing a computer to execute a process, the process comprising:
linking a first file image with a first user image and displaying the first file image and the first user image, the first file image representing a file linked with an account of a first user, the first user image representing the first user; and
linking a second file image with a second user image and displaying the second file image and the second user image together with the first file image and the first user image, the second file image representing a file linked with an account of a second user, the second user image representing the second user, the second user being different from the first user.
